(19) United States
(12) Patent Application Publication
(10) Pub. No.: US 2007/0020470 A1
(43) Pub. Date: Jan. 25, 2007

(54) Optical film and image display apparatus panel using the same

(75) Inventors: Tomoki Inakura, Osaka (JP); Teruhisa Miyata, Osaka (JP); Noriaki Otani, Osaka (JP); Sadamu Kuse, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/491,145

(22) Filed: Jul. 24, 2006

(30) Foreign Application Priority Data
Jul. 25, 2005 (JP) 2005-214969

(51) Int. Cl. B32B 27/36

(52) U.S. Cl. 428/483

(57) ABSTRACT

The present invention provides an optical film including: a base; a first functional layer provided on one principal plane of the base via a first adhesion-improving layer; and a second functional layer that is different from the first functional layer and is provided on the other principal plane of the base via a second adhesion-improving layer. The first adhesion-improving layer contains a resin that is different from a resin contained in the second adhesion-improving layer, and the second functional layer contains a resin of the same type as the resin contained in the second adhesion-improving layer. The optical film according to the present invention achieves excellent adhesion between the respective functional layers and the base as well as excellent reflectance spectral characteristics.

### BACKGROUND OF THE INVENTION

1. Field of the Invention

The present invention relates to an optical film and an image display apparatus panel using the same.

2. Description of the Related Art

The use of high-definition and large-screen flat panel displays (FPDs), typified by a plasma display panel (PDP) and the like, has been expanding rapidly. The PDP needs to include an antireflection layer having an antireflection function in order to prevent reflected glare of external light on a display screen. Furthermore, the PDP has a problem in that, at the time of plasma discharge, it releases unnecessary near-infrared rays, which adversely affect peripheral devices using electronic components. In particular, malfunction of remote controls of a television, an air conditioner, etc. is caused by these near-infrared rays. On this account, it is necessary to provide a near-infrared absorption layer having a function of absorbing near-infrared rays at the front of the display.

For the reasons stated above, the PDP employs a front filter that is produced by adhering a film having an antireflection function and a film having a function of absorbing near-infrared rays separately to a transparent glass substrate or a resin substrate. However, a conventional front filter has a problem in that, since the antireflection layer and the near-infrared absorption layer are provided as separate films, the number of components used in the filter increases, which results in high cost and reduces the yield at the time of adhering these components, for example. In recent years, an optical film has been proposed in which, in order to improve the adhesion between respective films composing the optical film and to simplify the manufacturing process, a single film has these functions (JP 10-156991 A, JP 2005-62430 A, JP 2005-107209 A, JP 2004-345333 A, JP 2003-177209 A).

However, the film disclosed in JP 10-156991 A has a problem in that a surface thereof is susceptible to damage because it does not include a hard coat layer. Furthermore, although the film disclosed in JP 2005-62430 A or JP 2005-107209 A includes a hard coat layer, since adhesion-improving layers provided on both principal planes of a base are of the same type, the adhesion between the hard coat layer and the base or the adhesion between a near-infrared absorption layer provided on a side opposite to the hard coat layer and the base may be insufficient. In addition, owing to the interference of light at the hard coat layer, crests and troughs may appear in the reflectance spectrum of reflected light so that interference fringes are generated to degrade the visibility of the PDP screen. In the case where layers with different functions respectively are provided on both principal planes of a base, it is necessary to provide adhesion-improving layers suitable for the respective functional layers. Although JP 2004-345333 A discloses a method of suppressing the interference fringes that are generated when functional layers are provided on a base via primer layers, adhesion-improving layers provided on both principal planes of the base also are of the same type. Thus, when resins contained in the functional layers provided on both the principal planes are different from each other, the adhesion between the respective functional layers and the base may be insufficient. JP 2003-177209 A also discloses a method of suppressing the interference fringes by providing an interference layer. However, in JP 2003-177209 A, the adhesion between a functional layer and a base still may be insufficient.

### SUMMARY OF THE INVENTION

The optical film according to the present invention is an optical film including: a base; a first functional layer provided on one principal plane of the base via a first adhesion-improving layer; and a second functional layer that is different from the first functional layer and is provided on the other principal plane of the base via a second adhesion-improving layer. The first adhesion-improving layer contains a resin that is different from a resin contained in the second adhesion-improving layer, and the second functional layer contains a resin of the same type as the resin contained in the second adhesion -improving layer.

Furthermore, an image display apparatus panel according to the present invention includes the above-described optical film of the present invention.

According to the present invention, it is possible to provide an optical film that, even though a first functional layer (e.g., a hard coat layer) is provided on one principal plane of a base and a second functional layer (e.g., a near-infrared absorption layer) is provided on the other principal plane of the base, can achieve excellent adhesion between the base and each of the functional layers and does not generate interference fringes. Furthermore, according to the present invention, it is possible to provide an image display apparatus panel that is suitable for FPDs, especially for a PDP, by using the above-described optical film.

### BRIEF DESCRIPTION OF THE DRAWINGS

FIG. 1 is a sectional view showing an example of an optical film according to the present invention.

FIG. 2 is a sectional view showing another example of the optical film according to the present invention.

FIG. 3 is a sectional view showing an example of an image display apparatus panel according to the present invention.

FIG. 4 is a diagram showing an example of a reflectance spectrum of the optical film.

### DETAILED DESCRIPTION OF THE INVENTION

The inventors of the present invention conducted a keen study on an optical film in which different functional layers are provided on respective principal planes of a base. As a result, the inventors found that an optical film with the following configuration can achieve the above-described object, thereby completing the present invention. Hereinafter, the present invention will be described by way of illustrative embodiments.

### Embodiment 1

First, an optical film according to the present invention will be described. The optical film according to the present invention includes a base, a first functional layer provided on one principal plane of the base via a first adhesion-improving layer, and a second functional layer that is different from the first functional layer and is provided on the other principal plane of the base via a second adhesion-improving layer. The first adhesion-improving layer contains a resin that is different from a resin contained in the second adhesion-improving layer. When the resin contained in the first adhesion-improving layer and the resin contained in the second adhesion-improving layer are different from each other, suitable resins can be selected for the respective adhesion-improving layers depending on the functional layers that are in contact with them. This improves the adhesion between the respective functional layers and the base and suppresses the generation of interference fringes.

Furthermore, in the optical film according to the present invention, the second functional layer contains a resin of the same type as the resin contained in the second adhesion-improving layer. By appropriate selection of the resin contained in the second functional layer and the resin contained in the second adhesion-improving layer that is in contact with the second functional layer, it is possible to improve the adhesion between the second functional layer and the base.

It is to be noted here that the resin contained in the first functional layer and the resin contained in the first adhesion-improving layer also may be of the same type. However, when the resin contained in the first functional layer contains a large number of functional groups, the adhesion is improved by the interaction between the resin contained in the first functional layer and the resin contained in the first adhesion-improving layer. Thus, it is not always necessary that the resin contained in the first functional layer and the resin contained in the first adhesion-improving layer are of the same type.

Note here that “resins are of the same type” as used in the context of the present invention means that the resins are common in binding group contained in their main skeletons or that the resins are polymers derived from low-molecular-weight substances (monomers, oligomers) belonging to the same group.

Also note that an “adhesion-improving layer” as used in the context of the present invention refers to a layer provided so as to be in direct contact with a surface of the base. The adhesion-improving layer serves to improve the adhesion between the base and the functional layer provided thereon and to provide an optical film with excellent spectral characteristics. Moreover, the adhesion-improving layer can produce an effect of improving the smoothness, ease of winding, and wear characteristics of the base.

Examples of the resin used for the adhesion-improving layer include polyester resins, acrylic resins, urethane resins, epoxy resins, and polyamide resins, which can be used as appropriate depending on the functional layer that is in contact with the adhesion-improving layer. These resins can be used either alone or as a polymer blend of at least two types thereof. It is more preferable to copolymerize a component containing a hydrophilic group such as a carboxyl group or a hydroxyl group with these resins, because this further improves the adhesion between the adhesion-improving layer and the base.

The adhesion-improving layer may contain at least one type of particles selected from inorganic particles and heat resistant polymer particles, in order to improve handling properties of the base such as smoothness, ease of winding, and blocking resistance and wear characteristics of the base such as wear resistance and scratch resistance and adjust the refractive index. Examples of the particles include inorganic particles such as particles of calcium carbonate, calcium phosphate, silica, kaoline, talc, titanium dioxide, alumina, barium sulfate, calcium fluoride, lithium fluoride, zeolite, and molybdenum sulfide and organic particles such as crosslinked polymer particles and particles of calcium oxalate. Among these, silica particles are suitable because high transparency can be achieved easily. The average particle diameter of the particles generally is in the range from 0.005 to 1.0 μm, preferably from 0.005 to 0.5 μm, and more preferably from 0.005 to 0.1 μm. When the average particle diameter is more than 1.0 μm, the surface of the adhesion-improving layer is roughened, so that the transparency of the optical film tends to decrease. The average particle diameter of the particles can be measured with a laser diffraction particle size distribution analyzer. The content of the particles in the adhesion-improving layer generally is 60 wt % or less, preferably 50 wt % or less, and more preferably 40 wt % or less. When the content of the particles is more than 60 wt %, the adhesion-improving property of the optical film may be degraded.

The adhesion-improving layer can be formed by preparing a coating solution that contains the above-described resin, inorganic particles and/or heat resistant polymer particles, etc., and then coating this coating solution onto the base. The coating method is not particularly limited, and can be, for example, reverse roll coating, gravure coating, kiss coating, a roll brush method, spray coating, air knife coating, bar coating using a wire bar, a method using a pipe doctor coater, dip coating, curtain coating, etc. These methods can be used either alone or in combination of at least two types thereof.

The above-described coating solution may be coated onto a base film that has been subjected to biaxial stretching and thermal fixation. Alternatively, the coating solution may be coated onto an unstretched base film and thereafter the base film may be subjected to stretching and thermal fixation. However, in order to coat the coating solution uniformly, it is preferable to coat the coating solution before stretching the base film. The solid content in the coating solution generally is 30 wt % or less, preferably 10 wt % or less. The amount of the coating solution to be coated is 0.01 to 5 g, preferably 0.2 to 4 g per m² of the film being conveyed. In order to achieve sufficient adhesion with the functional layer, the amount of the coating solution to be coated needs to be set to at least 0.01 g per m² of the film. The cleanliness class of the environment under which the coating solution is coated preferably is not more than 1000 so as to decrease the adherence of dust.

The thickness of the adhesion-improving layer preferably is not less than 20 nm and not more than 1 μm, more preferably not less than 50 nm and not more than 0.7 μm. When the thickness of the adhesion-improving layer is less than 20 nm, the effect of improving the adhesion between the functional layer and the base becomes small. On the other hand, the thickness of the adhesion-improving layer of more than 1 μm is not preferable because not only the effect of improving the adhesion becomes saturated but also it is disadvantageous in terms of cost and also because the optical film become unnecessarily thick. In the case where it is necessary to decrease the reflected light at the interface between the functional layer and the base so as to suppress the generation of interference fringes due to the functional layer as will be described later, the thickness of the adhesion-improving layer (d_{P}) is set so that the relationship expressed by the following equation (1) is satisfied. By doing so, the reflected light at the above-described interface can be reduced effectively, thus preventing the generation of interference fringes. It the equation (1), N is a natural number, λ is a wavelength of light, which is generally a wavelength around 550 nm because this provides high visibility for human eyes, and n_{P} is a refractive index of the adhesion-improving layer.
d_{P}=(2N−1)×λ/(4n_{P}) (1)

The functions of the first functional layer and the second functional layer are different from each other. Examples of the function include scratch resistance, near-infrared absorptivity, conductivity, an optically compensating function, and water vapor barrier properties. Note here that a plurality of functional layers may be provided on one principal plane of the base, or alternatively, a single functional layer may have a plurality of functions. Moreover, an antireflection layer, an adhesive layer, etc. may be provided on an outermost functional layer.

One example of the first functional layer is a hard coat layer. By providing a hard coat layer, it is possible to impart scratch resistance to the optical film. The surface hardness of the hard coat layer preferably is H or harder, more preferably 2H or harder according to the evaluation by the pencil hardness test conducted in accordance with JIS K5400. The material of the hard coat layer is not particularly limited as long as it has high hardness and also has transparency, and can be, for example, a thermosetting resin such as an urethane resin, a melamine resin, or an epoxy resin, or an ultraviolet-curing resin containing a polyfunctional or monofunctional acrylate monomer/oligomer and a photopolymerization initiator together with various additives. Also, it is possible to use a polymer blend obtained by further adding a polyester resin etc. to the above-described resin. Furthermore, it is more preferable that the material of the hard coat layer contains a functional group that acts on the first adhesion-improving layer that is in direct contact with the hard coat layer, because this allows the adhesion between the hard coat layer and the first adhesion-improving layer to be further improved. Still further, by adding inorganic fine particles to the above-described resin, the hard coat layer can have harder surfaces, shrinkage caused by hardening of the resin can be reduced, and the refractive index and the conductivity can be controlled. The material of the inorganic fine particles can be, for example, silicon dioxide (silica), tin-doped indium oxide, antimony-doped tin oxide, zirconium oxide, or the like.

There is no particular limitation on the method of forming the hard coat layer on the base. As in the case of the adhesion-improving layer described above, the hard coat layer also can be formed by coating a coating solution containing the above-described materials onto the base. The method of coating the coating solution is not particularly limited, and can be, for example, a coating method such as roll coating, die coating, air knife coating, blade coating, spin coating, reverse coating, or gravure coating, or a printing method such as gravure printing, screen printing, offset printing, or ink-jet printing. The thickness of the hard coat layer preferably is 1 μm to 10 μm, more preferably 2 μm to 7 μm. When the thickness of the hard coat layer is less than 1 μm, it becomes difficult for the hard coat layer to maintain a sufficient hardness. On the other hand, when the thickness of the hard coat layer is more than 10 μm, cracks may be generated or curling (film warping) may occur.

When the first functional layer is a hard coat layer, by providing a low refractive index layer having a lower refractive index than the hard coat layer on the hard coat layer, an antireflection effect is produced so that reflected glare of external light can be prevented. In general, this low refractive index layer is set so that an optical thickness, which is the product of the refractive index and the thickness, would be λ/4. Note here that, as λ, a wavelength around 550 nm that provides high visibility for human eyes generally is employed.

One example of the second functional layer is a near-infrared absorption layer. By providing a near-infrared absorption layer, it is possible to impart near-infrared absorptivity to the optical film. The material of the near-infrared absorption layer is not particularly limited as long as it has transparency and absorbs near-infrared rays. In general, a resin in which a near-infrared absorption compound is dispersed is used as the material of the near-infrared absorption layer. As the near-infrared absorption compound, an organic dye having a maximum absorption wavelength in the near-infrared region preferably is used. Examples of such an organic dye include those based on aminium, azo, azine, anthraquinone, indigoid, oxazine, squarylium, stilbene, triphenylmethane, naphthoquinone, diimonium, phthalocyanine, cyanine, and polymethine. Examples of the resin include polyester resins, acrylic resins, polyurethane resins, polyvinyl chloride resins, epoxy resins, polyvinyl acetate resins, polystyrene resins, cellulose resins, and polybutyral resins. It is also possible to use a polymer blend obtained by combining at least two types of these resins. It is to be noted that, when the resin contains a large number of functional groups, the functional groups may act on the near-infrared absorption compound to degrade the near-infrared absorptivity thereof. On this account, it is preferable that the resin contains a small number of functional groups.

In the present invention, the resin contained in the second functional layer and the resin contained in the second adhesion-improving layer are of the same type. Thus, even when the near-infrared absorption layer (the second functional layer) contains a resin containing a small number of functional groups, the adhesion between the near-infrared absorption layer and the base is not degraded. Accordingly, in the case where an acrylic resin containing a small number of functional groups, for example, is used as the resin contained in the near-infrared absorption layer, by using an acrylic resin as the resin contained in the second adhesion-improving layer as well, the adhesion between the near-infrared absorption layer and the second adhesion-improving layer is improved, which, in turn, improves the adhesion between the near-infrared absorption layer and the base.

There is no particular limitation on the method of forming the near-infrared absorption layer on the base. As in the case of the hard coat layer described above, the near-infrared absorption layer also can be formed by coating a coating solution containing the above-described materials onto the base. The method of coating the coating solution is not particularly limited, and can be, for example, a coating method such as roll coating, die coating, air knife coating, blade coating, spin coating, reverse coating, or gravure coating, or a printing method such as gravure printing, screen printing, offset printing, or ink-jet printing. The thickness of the near-infrared absorption layer preferably is 1 μm to 10 μm, more preferably 2 μm to 7 μm. When the thickness of the hard coat layer is less than 1 μm, it becomes difficult for the near-infrared absorption layer to absorb near-infrared rays sufficiently. On the other hand, when the thickness of the near-infrared absorption layer is more than 10 μm, cracks may be generated or curling (film warping) may occur.

Preferably, the near-infrared absorption layer contains a compound having a maximum absorption wavelength in a wavelength region ranging from 850 nm to 1100 nm. When the near-infrared absorption layer contains such a compound, it becomes possible to decrease the transmittance of near-infrared rays in the wavelength region ranging from 850 nm to 1100 nm without significantly decreasing the transmittance of visible light with a wavelength ranging from 400 nm to 850 nm. As the compound having a maximum absorption wavelength in a wavelength region ranging from 850 nm to 1100 nm, the above-described organic dyes can be used either alone or in combination of at least two types thereof. This allows the optical film according to the present embodiment to be used suitably as a near-infrared absorption filter for a PDP or the like.

To the near-infrared absorption layer, a compound that blocks a neon bright-line spectrum (orange) of a PDP can be added as appropriate. This allows the PDP to develop red more vividly. As the compound that blocks the neon bright-line spectrum, it is possible to use an organic dye having a maximum absorption wavelength in a wavelength region ranging from 580 nm to 620 nm. Examples of such an organic dye include those based on cyanine, squarylium, diphenylmethane, triphenylmethane, oxazine, azine, thiopyrylium, viologen, azo, azo metal complex salts, azaporphyrin, bisazo, anthraquinone, and phthalocyanine.

The type of the resin to be uses as the material of the near-infrared absorption layer, the content of the near-infrared absorption compound, and the like may be determined as appropriate so that the spectral transmittance of the optical film is not more than 20% in the entire wavelength region ranging from 850 nm to 1100 nm.

The material of the base is not particularly limited as long as it has transparency. For example, the base can be formed by processing a resin such as a saturated polyester resin, a polycarbonate resin, a polyacrylic ester resin, an alicyclic polyolefin resin, a polystyrene resin, a polyvinyl chloride resin, or a polyvinyl acetate resin into a film or a sheet. Examples of the method of processing the resin into a film or a sheet include extrusion molding, calender molding, compression molding, injection molding, and a method of dissolving the resin in a solvent and casting. The thickness of the base generally is about 10 μm to about 500 μm. Additive such as an antioxidant, a flame retardant, a heat resistance-imparting agent, a UV absorber, a lubricant, and an antistatic agent may be added to the resin.

When a transparent layer is formed on the base, or when the base has a refractive index different from that of a layer formed on the base, crests and troughs may appear in the reflectance spectrum owing to the interference of light reflected by the upper surface and the lower surface of the layer, so that interference fringes may be observed visually. Such a phenomenon is significant when the optical film is used under a light source containing a large number of bright-line spectra with a narrow bandwidth, e.g., a fluorescent lamp, in particular, a three-band fluorescent lamp.

As a remedy against this phenomenon, it is preferable that a relationship expressed by either n_{F1}≦n_{P1}≦n_{B} or n_{F1}≧n_{P1}≧n_{B} and a relationship expressed by |n_{P1}−n_{B}|≦0.1 are satisfied, where n_{B} is a refractive index of the base, n_{P1} is a refractive index of the first adhesion-improving layer, and n_{F1} is a refractive index of the first functional layer, because this allows the reflectance spectral characteristics of the optical film to be improved. In other words, when the refractive indices of the base and the first functional layer are different from each other, it is possible to improve the reflectance spectral characteristics by setting the refractive index of the first adhesion-improving layer to be between the refractive indices of these two layers. When the refractive indices of the base and the first functional layer are the same, the refractive index of the first adhesion-improving layer is set so as to be equal to the refractive indices of the base and the first functional layer. The effect produced by setting the refractive index of the first adhesion-improving layer within the above-described range is remarkable particularly when the difference between the refractive indices of the base and the first functional layer is large, namely, more than 0.03.

The method of controlling the refractive index n_{B} of the base, the refractive index n_{P1} of the first adhesion-improving layer, and the refractive index n_{F1} of the first functional layer so as to fall within the above-described range is not particularly limited, and they can be controlled by appropriate selection of the type of resin to be used, the type and the amount of inorganic particles or organic particles to be added, etc. Note here that the refractive index can be measured using an optical thin-film measurement system “Film Tek 3000” manufactured by SCI.

Among various materials used for the base, polyethylene naphthalate (PEN), polyethylene terephthalate (PET), polycarbonate (PC), and the like, for example, are materials with a relatively high refractive index, namely, 1.59 to 1.75. On the other hand, triacetyl cellulose (TAC), polymethyl methacrylate (PMMA), polypropylene (PP), tetrafluoroethylene-hexafluoropropylene copolymer (FEP), and the like are materials with a relatively low refractive index, namely, not more than 1.50. By using various resins having a refractive index of 1.45 to 1.6 and various particles having a refractive index of 1.46 to 2.7 in combination with the base formed using the above-described materials, the relationship between the refractive indices of the base, the adhesion-improving layers, and the functional layers can be adjusted so as to satisfy the above-described preferable range. The refractive index n of the particle-containing resin layer can be determined based on the relationship expressed by the following equation (2), where x is a volume fraction of the particles in the resin layer, nₚ is a refractive index of the particles, and n_{b} is a refractive index of the resin,
n=n_{b}+x×(nₚ−n_{b}) (2)

Examples of the resin having a high refractive index include those containing a cyclic group and those containing a halogen atom other than fluorine. The resins containing a cyclic group are more preferable than the resins containing a halogen atom other than fluorine, because the resins containing a cyclic group are free from the problems such as coloring caused by halogen, odor, and toxicity. It is also possible to use a resin containing both a cyclic group and a halogen atom other than fluorine. The cyclic group encompasses an aromatic group, a heterocyclic group, and an aliphatic cyclic group. Among these, an aromatic group is particularly preferable. This is because resins containing an aromatic group have a high refractive index.

Examples of the resin having a high refractive index include: polybis(4-methacryloylthiophenoxy)sulfide, polyvinylphenyl sulfide, poly 4-methacroyloxyphenyl-4′-methoxyphenylthioether, polystyrene, styrene copolymers, polycarbonate, melamine resins, phenol resins, epoxy resins, polyurethane obtained by the reaction between cyclic (alicyclic or aromatic) isocyanate and polyol, polythiourethane obtained by the reaction between xylylene diisocyanate and benzendiol, polythiourethane obtained by the reaction between trithioisocyanate and trimercaptobenzene, and polyphenylene sulfide. Particularly preferable are sulfide resins containing an aromatic group and thiourethane resins containing an aromatic group.

Examples of an inorganic oxide having a high refractive index of 1.6 to 2.7 include ZnO, ZrO₂, TiO₂, SnO₂, Al₂O₃, Sb₂O₃, CeO, TaO₂, Y₂O₃, and La₂O₃. Examples of a material having a low refractive index of not more than 1.5 include metal oxides and metal fluorides, such as SiO₂, MgF₂, LiF, AlF₃, and Na₃AlF₆.

Hereinafter, an optical film according to the present invention will be described with reference to the drawings. It is to be noted that, when the explanation of the optical film overlaps with that already described in the above embodiment, it may be omitted in the following.

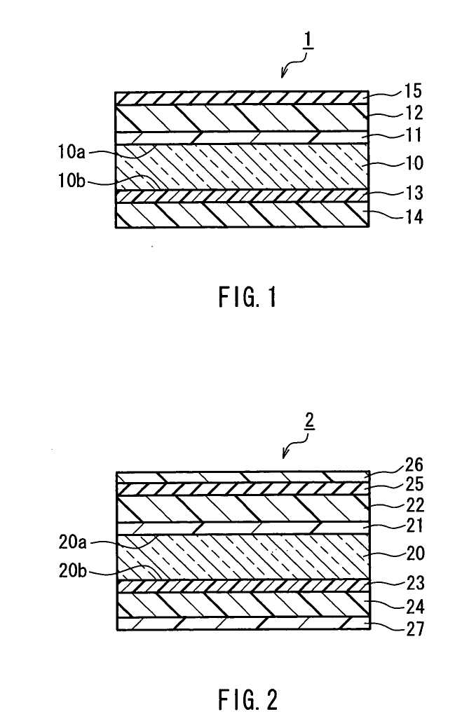

FIG. 1 is a sectional view showing an example of the optical film according to the present invention. In FIG. 1, an optical film 1 includes a base 10, a first functional layer 12 provided on one principal plane 10a of the base 10 via a first adhesion-improving layer 11, and a second functional layer 14 provided on the other principal plane 10b of the base 10 via a second adhesion-improving layer 13. An antireflection layer 15 is provided on the first functional layer 12.

The first adhesion-improving layer 11 contains a resin that is different from a resin contained in the second adhesion-improving layer 13, and the second functional layer 14 contains a resin of the same type as the resin contained in the second adhesion-improving layer 13.

The thickness of the first adhesion-improving layer 11 and the thickness of the second adhesion-improving layer 13 are both set to not less than 20 nm and not more than 1 μm, and the thickness of the first functional layer 12 and the thickness of the second functional layer 14 are both set to not less than 1 μm and not more than 10 μm. This allows the first adhesion-improving layer 11, the second adhesion-improving layer 13, the first functional layer 12, and the second functional layer 14 to exhibit their functions efficiently.

Preferably, a relationship expressed by either n_{F1}≦n_{P1}≦n_{B} or n_{F1}≧n_{P1}≧n_{B} and a relationship expressed by |n_{P1}−n_{B}|≦0.1 are satisfied, where n_{B} is a refractive index of the base 10, n_{P1} is a refractive index of the first adhesion-improving layer 11, and n_{F1} is a refractive index of the first functional layer 12. With this configuration, it is possible to improve the reflectance spectral characteristics of the optical film 1.

By providing a hard coat layer as the first functional layer 12, it is possible to impart scratch resistance to the optical film 1. By providing a near-infrared absorption layer as the second functional layer 14, it is possible to impart near-infrared absorptivity to the optical film 1.

FIG. 2 is a sectional view showing another example of the optical film according to the present invention. In FIG. 2, an optical film 2 includes a base 20, a first functional layer 22 provided on one principal plane 20a of the base 20 via a first adhesion-improving layer 21, and a second functional layer 24 provided on the other principal plane 20b of the base 20 via a second adhesion-improving layer 23. An antireflection layer 25 and a protective layer 26 are provided on the first functional layer 22. An adhesive layer 27 is provided on the second functional layer 24. By providing the protective layer 26, it is possible to prevent the optical film 2 from being damaged during handling. By providing the adhesive layer 27, it becomes possible to adhere the optical film 2 to other members easily. Except for the above, the optical film 2 has the same configuration as the optical film 1 shown in FIG. 1.

### Embodiment 2

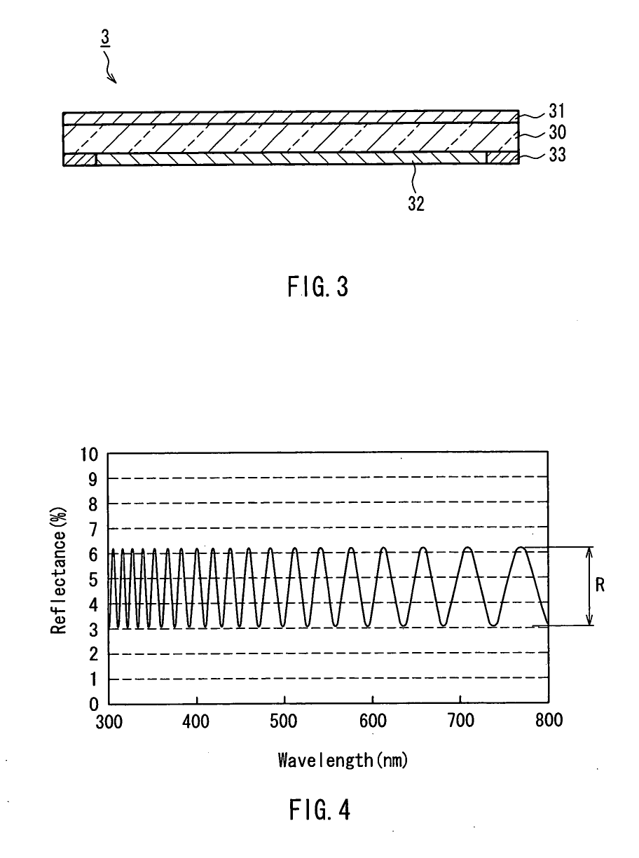

Next, an image display apparatus panel according to the present invention will be described with reference to the drawings. FIG. 3 is a sectional view showing an example of an image display apparatus panel according to the present invention. An image display apparatus panel 3 according to the present embodiment includes a substrate 30, a multifunction optical film 31 provided on one principal plane of the substrate 30, an electromagnetic-wave shield 32 provided on the other principal plane of the substrate 30, and an electrode (a ground) 33. The material of the substrate 30 is not particularly limited as long as it has transparency, and can be a tempered glass or the like, for example. As the multifunction optical film 31, it is possible to use the above-described optical film according to Embodiment 1 of the present invention as it is, for example. According to the image display apparatus panel 3 of the present embodiment, the multifunction optical film 31 can be provided with, for example, a hard coat layer and a near-infrared absorption layer. Thus, the image display apparatus panel 3 can have functions of such layers in combination with the function of the electromagnetic-wave shield 32 and thus can be used as a display front plate to be disposed at the front of, in particular, a PDP.

Hereinafter, the present invention will be described by way of examples, but the present invention is by no means limited to the following examples. It is to be noted that, in the examples and comparative example given below, the term “part” means part by weight, and the term “average particle diameter” means a number-average particle diameter determined using a laser diffraction particle size distribution analyzer.

### EXAMPLE 1

An optical film to be subjected to evaluation (hereinafter referred to simply as an “evaluation optical film”) having the same configuration as the optical film shown in FIG. 1 was produced in the following manner.

<Preparation of Coating Material for Forming First Adhesion-Improving Layer>

Colloidal silica particles “Snowtex OL” (NISSAN CHEMICAL INDUSTRIES, LTD.) were mixed and stirred in a polyester resin emulsion “Pesresin A-520” (Takamatsu Oil & Fat Co., Ltd.) so that the mixture would exhibit the refractive index shown in Table 1 after being dried. Thus, a coating material for forming a first adhesion-improving layer was prepared.

<Preparation of Coating Material for Forming Second Adhesion-Improving Layer>

Colloidal silica particles “Snowtex OL” NISSAN CHEMICAL INDUSTRIES, LTD.) were mixed and stirred in an acrylic resin emulsion “AD 53” (NIPPON NSC LTD.) so that the mixture would exhibit the refractive index shown in Table 1 after being dried. Thus, a coating material for forming a second adhesion-improving layer was prepared.

Next, a 100 μm thick UV-screening PET film was provided as a base. The above-described coating material for forming a first adhesion-improving layer was coated onto one surface of this PET film to form an 88 nm thick first adhesion-improving layer, and the above-described coating material for forming a second adhesion-improving layer was coated onto the other surface of the PET film to form a 60 nm thick second adhesion-improving layer. Thus, the base provided with the adhesion-improving layers was produced.

<Preparation of Coating Material for Forming First Functional Layer (Hard Coat Layer)>

Materials shown below were mixed and stirred to prepare a coating material for forming a first functional layer.
(1) Zinc antimonate fine particles “CELNAX CX-Z210IP-F2” (NISSAN CHEMICAL INDUSTRIES, LTD.): 2 parts
(2) Pentaerythritol triacrylate: 13 parts
(3) Dipentaerythritol hexaacrylate: 6 parts
(4) Photopolymerization initiator “IRGACURE (registered trademark) 907” (Ciba Specialty Chemicals Inc.): 2 parts
(5) Isopropyl alcohol: 77 parts

Then, the thus-prepared coating material for forming a first functional layer was coated onto the first adhesion-improving layer of the base provided with the adhesion-improving layers using a micro-gravure coater (Yasui Seiki Co.) and then was dried. Thereafter, the thus-formed coating was hardened by being subjected to ultraviolet irradiation with a dose of 150 mJ/cm². Thus, a 3 μm thick first functional layer (hard coat layer) was formed. The pencil hardness of this hard coat layer was measured in accordance with JIS K5400 and found to be 2H.

<Preparation of Coating Material for Forming Antireflection Layer>

Materials shown below were mixed and stirred to prepare a coating material for forming an antireflection layer.
(1) Hollow silica fine particles (CATALYSTS & CHEMICALS IND. CO., LTD.): 60 parts
(2) Pentaerythritol triacrylate: 20 parts
(3) Dipentaerythritol hexaacrylate: 20 parts
(4) Photopolymerization initiator “IRGACURE (registered trademark) 907” (Ciba Specialty Chemicals Inc.): 5 parts
(5) High molecular surface modifying agent “MODIPER F200” (NOF CORPORATION): 1 part
(6) Isopropyl alcohol: 2000 parts

Then, the thus-prepared coating material for forming an antireflection layer was coated onto the first functional layer of the base provided with the adhesion-improving layers using the above-described micro-gravure coater and then was dried. Thereafter, the thus-formed coating was hardened by being subjected to ultraviolet irradiation with a dose of 300 mJ/cm². Thus, a 107 nm thick antireflection layer was formed.

<Preparation of Coating Material for Forming Second Functional Layer (Near-Infrared Absorption Layer)>

Materials shown below were mixed and stirred to prepare a coating material for forming a second functional layer.
(1) Acrylic resin having a small number of functional groups, “PHORET” (Soken Chemical & Engineering Co., Ltd.): 100 parts
(2) Aromatic diimonium dye “CIR-1085” (Japan Carlit Co., Ltd.): 6 parts
(3) Near-infrared absorption compound containing a cyanine site and a dithiol metal complex site, “SD50-E04N” (SUMITOMO SEIKA CHEMICALS CO., LTD., maximum absorption wavelength: 877 nm): 1 part
(4) Near-infrared absorption compound containing a cyanine site and a dithiol metal complex site, “SD50-E05N” (SUMITOMO SEIKA CHEMICALS CO., LTD., maximum absorption wavelength: 833 nm): 1 part
(5) Methyl ethyl ketone: 125 parts
(6) Toluene: 460 parts

Then, the thus-prepared coating material for forming a second functional layer was coated onto the second adhesion-improving layer of the base provided with adhesion-improving layers using the above-described micro-gravure coater so as to form a 4 μm thick second functional layer (near-infrared absorption layer). Thus, an evaluation optical film was produced.

### EXAMPLE 2

An evaluation optical film was produced in the same manner as in Example 1, except that the amount of the colloidal silica particles added was adjusted so that the first adhesion-improving layer would exhibit the refractive index shown in Table 1.

### EXAMPLE 3

An evaluation optical film was produced in the same manner as in Example 1, except that a 100 μm thick TAC film was used as the base instead of the PET film, the amount of the zinc antimonate fine particles added was adjusted so that the first functional layer would exhibit the refractive index shown in Table 1, and the amount of the colloidal silica particles added was adjusted so that the first adhesion-improving layer would exhibit the refractive index shown in Table 1.

### EXAMPLE 4

An evaluation optical film was produced in the same manner as in Example 3, except that the amount of the zinc antimonite fine particles added was adjusted so that the first functional layer would exhibit the refractive index shown in Table 1 and the amount of the colloidal silica particles added was adjusted so that the first adhesion-improving layer would exhibit the refractive index shown in Table 1.

### EXAMPLE 5

An evaluation optical film was produced in the same manner as in Example 1, except that the antireflection layer was not provided.

### EXAMPLE 6

An evaluation optical film was produced in the same manner as in Example 1, except that the amount of the colloidal silica particles added was adjusted so that the first adhesion-improving layer would exhibit the refractive index shown in Table 1.

### EXAMPLE 7

An evaluation optical film was produced in the same manner as in Example 1, except that the amount of the colloidal silica particles added was adjusted so that the first adhesion-improving layer would exhibit the refractive index shown in Table 1.

### COMPARATIVE EXAMPLE 1

An evaluation optical film was produced in the same manner as in Example 1, except that the composition of the second adhesion-improving layer was changed so as to be the same as that of the first adhesion-improving layer.

The properties of the optical films according to Examples 1 to 7 and Comparative Example 1 were evaluated in the following manner.

<Adhesion>

A cross-cut peeling test was conducted in accordance with JIS K5600-5-6 so as to evaluate the adhesion between the base and each of the first functional layer and the second functional layer. The results are shown in Table 1. Specifically, in Table 1, the case where no peeling-off occurred in any of 100 grids was evaluated as “Good”, while other cases were evaluated as “Poor”.

<Interference Fringes>

The reflectance of each of the optical films in the visible light wavelength region (300 nm to 800 nm) was measured using a spectrophotometer “Ubest V-570” (JASCO Corporation) with the first functional layer side being the light incident side, thus obtaining the reflectance spectrum. Note here that the surface of the optical film subjected to the measurement was on the first functional layer side, and the surface of the optical film on the second functional layer side was roughened with a sandpaper and painted throughout with a black marker before carrying out the measurement so as to prevent reflection.

The extent of the interference fringes generated was evaluated based on the average value of ripples in the thus-measured reflectance spectrum in the wavelength region ranging from 500 nm to 600 nm. Note here that the ripple (R) refers to the difference (%) between a crest and a trough in the reflectance spectrum shown in FIG. 4. The results are shown in Table 1. In Table 1, the extent of the interference fringes generated was indicated as “Excellent”, “Good”, or “Fair” according to the following criteria.
Excellent: The ripple was less than 0.5%, so that substantially no interference fringes were observed.
Good: The ripple was less than 1.0%, so that the interference fringes were inconspicuous.
Fair: The ripple was 1.0% or more, so that the interference fringes were conspicuous.

In Table 1, the acrylic resin is indicated as Acr, the polyester resin is indicated as PEs, and the acrylic resin containing a small number of functional groups is indicated as n-Acr. The refractive indices of the respective layers also are shown in Table 1.

TABLE 1

| | | | | | | | | | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 1 |
| First | Resin | Acr | Acr | Acr | Acr | Acr | Acr | Acr | Acr |
| functional | Refractive | 1.54 | 1.54 | 1.60 | 1.61 | 1.54 | 1.54 | 1.54 | 1.54 |
| layer | index | | | | | | | | |
| First | Resin | PEs | PEs | PEs | PEs | PEs | PEs | PEs | PEs |
| adhesion- | Refractive | 1.60 | 1.55 | 1.55 | 1.60 | 1.60 | 1.52 | 1.67 | 1.60 |
| improving | index | | | | | | | | |
| layer | | | | | | | | | |
| Base | Resin | PET | PET | TAC | TAC | PET | PET | PET | PET |
| | Refractive | 1.66 | 1.66 | 1.49 | 1.49 | 1.66 | 1.66 | 1.66 | 1.66 |
| | index | | | | | | | | |
| Second | Resin | Acr | Acr | Acr | Acr | Acr | Acr | Acr | PEs |
| adhesion- | Refractive | 1.50 | 1.50 | 1.50 | 1.50 | 1.50 | 1.50 | 1.50 | 1.60 |
| improving | index | | | | | | | | |
| layer | | | | | | | | | |
| Second | Resin | n-Acr | n-Acr | n-Acr | n-Acr | n-Acr | n-Acr | n-Acr | n-Acr |
| functional | Refractive | 1.50 | 1.50 | 1.50 | 1.50 | 1.50 | 1.50 | 1.50 | 1.50 |
| layer | index | | | | | | | | |
| Adhesion | First | Good | Good | Good | Good | Good | Good | Good | Good |
| | functional | | | | | | | | |
| | layer | | | | | | | | |
| | Second | Good | Good | Good | Good | Good | Good | Good | Poor |
| | functional | | | | | | | | |
| | layer | | | | | | | | |

| | | | | | | | | |
|---|---|---|---|---|---|---|---|---|
| Interference fringes | Excellent | Good | Excellent | Good | Good | Fair | Fair | Excellent |

As apparent from Table 1, in the optical films according to Examples 1 to 7, the respective functional layers achieved better adhesion than those in the optical film according to Comparative Example 1 that did not satisfy the requirement of the present invention. Moreover, among the optical films according to Examples 1 to 7, the optical films according to Examples 1 and 3 that satisfied the relationship of n_{F1}≦n_{P1}≦n_{B} or n_{F1}≧n_{P1}≧n_{B} and the relationship expressed by |n_{P1}−n_{B}|≦0.1, generated substantially no interference fringes. The optical film according to Example 5 also satisfied the same relationships. However, since the optical film of Example 5 did not include an antireflection layer, some interference fringes were observed, but they were inconspicuous.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical film comprising:
a base;
a first functional layer provided on one principal plane of the base via a first adhesion-improving layer; and
a second functional layer that is different from the first functional layer and is provided on the other principal plane of the base via a second adhesion-improving layer,
wherein the first adhesion-improving layer contains a resin that is different from a resin contained in the second adhesion-improving layer, and
the second functional layer contains a resin of the same type as the resin contained in the second adhesion-improving layer.

2. The optical film according to claim 1, wherein no peeling-off is observed between the first functional layer, the first adhesion-improving layer, and the base nor between the second functional layer, the second adhesion-improving layer, and the base in a cross-cut peeling test conducted in accordance with JIS K5600-5-6.

3. The optical film according to claim 1, wherein a thickness of the first adhesion-improving layer and a thickness of the second adhesion-improving layer are both less than 1 μm, and a thickness of the first functional layer and a thickness of the second functional layer are both not less than 1 μm and not more than 10 μm.

4. The optical film according to claim 1, wherein a relationship expressed by either n_{F1}≦n_{P1}≦n_{B} or n_{F1}≧n_{P1}≧n_{B} and a relationship expressed by |n_{P1}−n_{B}|≦0.1 are satisfied, where n_{B} is a refractive index of the base, n_{P1} is a refractive index of the first adhesion-improving layer, and n_{F1} is a refractive index of the first functional layer.

5. The optical film according to claim 1, wherein each of the first adhesion-improving layer and the second adhesion-improving layer contains at least one type of resin selected from the group consisting of polyester resins, acrylic resins, urethane resins, epoxy resins, and polyamide resins.

6. The optical film according to claim 1, wherein the first functional layer is a hard coat layer.

7. The optical film according to claim 1, further comprising a low refractive index layer having a lower refractive index than the first functional layer, the low refractive index layer being provided as an outermost layer on the first functional layer side of the optical film.

8. The optical film according to claim 1, wherein the second functional layer is a near-infrared absorption layer.

9. An image display apparatus panel comprising the optical film according to claim 1.
